(19) United States
(12) Patent Application Publication
(10) Pub. No.: US 2026/0239185 A1
(43) Pub. Date: Aug. 13, 2026

(54) METHOD AND APPARATUS FOR IMPROVEMENTS IN AND RELATING TO SATELLITE ACCESS IN A TELECOMMUNICATION SYSTEM

(71) Applicant: Samsung Electronics Co., Ltd., Gyeonggi-do (KR)

(72) Inventors: Mahmoud WATFA, Middlesex (GB); Dandra Prasad BASAVARAJ, Bangalore (IN); Sivasankar COMARAVELOU, Bangalore (IN); Lalith KUMAR, Bangalore (IN); Sameer Kumar MANDAL, Bangalore (IN)

(21) Appl. No.: 19/157,630

(22) PCT Filed: Feb. 15, 2024
(86) PCT No.: PCT/KR2024/095202

§ 371 Date: Aug. 18, 2025

(30) Foreign Application Priority Data
Feb. 18, 2023 (IN) 202331011102
Jan. 17, 2024 (GB) 2400659.5

(51) Int. Cl. H04W 48/18; H04W 84/06; H04W 88/06

(52) U.S. Cl. CPC H04W 48/18; H04W 84/06; H04W 88/06

(57) ABSTRACT

The disclosure relates to a 5G or 6G communication system for supporting a higher data transmission rate. Disclosed is a method of operating a User Equipment, UE, communicatively coupled to a telecommunication network, PLMN, wherein If the UE supports disabling and re-enabling of UE's Narrow Band Internet of Things, NB-IoT, capability and the UE is in NB-S1 mode and is disabling the NB-IoT capability; the UE should select E-UTRAN, or if the UE supports Cellular Internet of Things, CIoT, Evolved Packet System, EPS, optimization it selects satellite E-UTRAN via “WB-E-UTRAN(LEO)”, “WB-E-UTRAN(MEO)”, or “WB-E-UTRAN(GEO)”, of the registered PLMN or a PLMN from a list of equivalent PLMNs.

### TECHNICAL FIELD

The present invention relates to improvements in managing and controlling satellite access in a telecommunication system.

### BACKGROUND ART

5G mobile communication technologies define broad frequency bands such that high transmission rates and new services are possible, and can be implemented not only in “Sub 6 GHz” bands such as 3.5GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

3GPP has developed solutions for the use of satellite access for connecting Internet of Things, IoT, devices to the core network such as Evolved packet Core, EPC, and for connecting other (non-IoT) devices to 5GC, noting that IoT over satellite connected to 5GC is not supported in Release 17 of the standard (whereas IoT over satellite connected to EPC is supported in Release 17).

### Solution to Problem

In accordance with an aspect of the disclosure, a method of operating a User Equipment, UE, communicatively coupled to a telecommunication network, PLMN, wherein If the UE supports disabling and re-enabling of UE's Narrow Band Internet of Things, NB-IoT, capability and the UE is in NB-S1 mode and is disabling the NB-IoT capability, the UE should select E-UTRAN, or if the UE supports Cellular Internet of Things, CIoT, Evolved Packet System, EPS, optimization it selects satellite E-UTRAN via “WB-E-UTRAN(LEO)”, “WB-E-UTRAN(MEO)”, or “WB-E-UTRAN(GEO)”, of the registered PLMN or a PLMN from a list of equivalent PLMNs.

In an embodiment of the disclosure, wherein if E-UTRAN, or in the case of the UE which supports CIoT EPS optimization if satellite E-UTRAN via “WB-E-UTRAN(LEO)”, “WB-E-UTRAN(MEO)”, or “WB-E-UTRAN(GEO)”, of the registered PLMN or a PLMN from the list of equivalent PLMNs cannot be found, the UE selects another Radio Access Technology, RAT, of the registered PLMN or a PLMN from the list of equivalent PLMNs.

In an embodiment of the disclosure, wherein the other RAT is one of GERAN, UTRAN, or NG-RAN if the UE has not disabled its N1 mode capability for 3GPP access.

In accordance with an aspect of the disclosure, a method of operating a User Equipment, UE, communicatively coupled to a telecommunication network, PLMN, wherein if the UE is disabling N1 mode capability for 3GPP access for a PLMN not due to redirection to Evolved Packet Core, EPC, the UE selects an E-UTRA cell connected to EPC or, if the UE supports CIoT EPS optimization, it selects a satellite E-UTRA cell connected to EPC via “WB-E-UTRAN(LEO)”, “WB-E-UTRAN(MEO)”, or “WB-E-UTRAN(GEO)”, of the registered PLMN or a PLMN from the list of equivalent PLMNs, if the UE supports S1 mode and the UE has not disabled its E-UTRA capability.

In an embodiment of the disclosure wherein if: an E-UTRA cell connected to EPC or, if the UE supports CIoT EPS optimization if a satellite E-UTRA cell connected to EPC via “WB-E-UTRAN(LEO)”, “WB-E-UTRAN(MEO)”, or “WB-E-UTRAN(GEO)”, of the registered PLMN or a PLMN from the list of equivalent PLMNs cannot be found, and the UE does not support S1 mode or the UE has disabled its E-UTRA capability, the UE selects another RAT of the registered PLMN or a PLMN from the list of equivalent PLMNs that the UE supports

In accordance with another aspect of the disclosure, method of operating a User Equipment, UE, communicatively coupled to a telecommunication network, PLMN, wherein if the UE is in WB-N1 mode, if lower layers do not provide an indication that a current E-UTRA cell is connected to EPC or lower layers do not provide an indication that the current E-UTRA cell supports CIoT EPS optimizations that are supported by the UE, the UE searches for a suitable E-UTRA cell connected to EPC or, if the UE supports CIoT EPS optimization, the UE selects a satellite E-UTRA cell connected to EPC via “WB-E-UTRAN(LEO)”, “WB-E-UTRAN(MEO)”, or “WB-E-UTRAN(GEO)”

In accordance with another aspect of the disclosure, a method of operating a User Equipment, UE, communicatively coupled to a telecommunication network, PLMN, wherein if lower layers cannot find a suitable E-UTRA cell connected to EPC, or if the lower layers cannot find a suitable satellite E-UTRA cell via “WB-E-UTRAN(LEO)”, “WB-E-UTRAN(MEO)”, or “WB-E-UTRAN(GEO)”, or there is no suitable E-UTRA cell connected to EPC, or there is no suitable satellite E-UTRA cell connected to EPC via “WB-E-UTRAN(LEO)”, “WB-E-UTRAN(MEO)”, or “WB-E-UTRAN(GEO)”, which supports CIoT EPS optimizations that are supported by the UE, the UE, indicates to lower layers to remain camped in E-UTRA cell connected to 5GCN, starts s timer and enters the state 5GMM-REGISTERED.LIMITED-SERVICE

In an embodiment of the disclosure, wherein the UE re-enables N1 mode capability for 3GPP access at expiry of the timer, if the timer had been started, and then proceeds with an appropriate 5GMM procedure.

### Advantageous Effects of Invention

According to an embodiment of the present disclosure, a satellite access in communication systems can be further improved.

### BRIEF DESCRIPTION OF DRAWINGS

The above and other aspects, features, and advantages of certain embodiments of the disclosure, will be more apparent from the following description taken in conjunction with the accompanying drawings in which:

FIG. 1 shows a flowchart according to an embodiment of the present disclosure;

FIG. 2 shows the configuration of a user equipment according to an embodiment of the disclosure.

FIG. 3 shows the configuration of a base station according to an embodiment of the disclosure.

Throughout the drawings, it should be noted that like reference numbers are used to depict the same or similar elements, features, and structures.

### MODE FOR THE INVENTION

The principles of operation of the present disclosure will now be described in detail with reference to the attached drawings. In the following description of the present disclosure, if a detailed description of a related known function or configuration is judged to unnecessarily obscure the essence of the present disclosure, the detailed description will be omitted. In addition, the terms described below are defined in consideration of the functions in the present disclosure and may vary depending on the intention or custom of the user or the operator. Therefore, the definitions should be taken in the context of the entire specification.

As used in the following description, terms for identifying access nodes, terms for referring to network entities, terms for referring to messages, terms for referring to interfaces between network entities, and terms for referring to various identifying information are exemplified for ease of explanation. Accordingly, the disclosure is not limited to the terms described herein, and other terms may be used to refer to objects having equivalent technical meaning.

Hereinafter, a base station is an entity that performs resource allocation for a user equipment, which may be at least one of gNode B, eNode B, Node B, a base station (BS), a wireless access unit, a base station controller, or a node on a network. A user equipment may include a user equipment (UE), a mobile station (MS), a cellular phone, a smartphone, a computer, or a multimedia system capable of performing communication functions. In the present disclosure, downlink (DL) refers to a wireless transmission path of a signal transmitted by a base station to a user equipment, and uplink (UL) refers to a wireless transmission path of a signal transmitted by a user equipment to a base station. In addition, while LTE or LTE-A systems may be described herein as an example, embodiments of the present disclosure may be applied to other communication systems having similar technical backgrounds or channel types. For example, fifth generation mobile communication technology (5G, new radio, NR) developed after LTE-A may be included as a system to which embodiments of the present disclosure may be applied, and 5G herein may be a concept that includes legacy LTE, LTE-A, and other similar services. In addition, the present disclosure may be applied to other communication systems with some modifications that do not substantially depart from the scope of the present disclosure as determined by a person skilled in the art. It will be understood that each block of the processing flowchart illustrations and combinations of the flowchart illustrations may be performed by computer program instructions.

These computer program instructions may be mounted on a processor of a general purpose computer, a special purpose computer, or other programmable data processing equipment, such that the instructions, when executed by the processor of the computer or other programmable data processing equipment, create means for performing the functions described in the flowchart block(s). These computer program instructions may be stored in computer-usable or computer-readable memory that may be directed to a computer or other programmable data processing equipment to implement the functions in a particular manner, so that the instructions stored in the computer-usable or computer-readable memory may produce a manufactured item comprising instructional means for performing the functions described in the flowchart block(s). The computer program instructions may also be mounted on a computer or other programmable data processing equipment and a series of operational steps are performed on the computer or other programmable data processing equipment to create a computer-executable process, such that the instructions performing the computer or other programmable data processing equipment may also provide steps for performing the functions described in the flowchart block(s). Before satellite access was introduced, 3GPP access for EPC and Fifth Generation Core, 5GC, was mainly E-UTRAN and New Radio, NR, radio (excluding other access types for GSM EDGE Radio Access Network (GERAN), Universal Terrestrial Radio Access Network (UTRAN), etc). Satellite access was hence introduced and is also considered to be a type of 3GPP access for which the term was defined in 3GPP TS 24.501:

“Satellite NG-RAN RAT type: In case of satellite Next Generation Radio Access Network, NG-RAN, access, Radio Access Type, RAT, types are used to distinguish different types of satellite NG-RAN access, as defined in 3GPP TS 38.413. In this version of the specification, the defined satellite NG-RAN RAT types are “NR(Low Earth Orbit, LEO)”, “NR(Medium Earth Orbit, MEO)” and “NR(Geostationary Earth Orbit, GEO)”.”

The above indicates that satellite NG-RAN is a new type of 3GPP access which is further composed of three RAT types: NR(LEO), NR(MEO) and NR(GEO).

The following is from 3GPP TS 24.301:
“Satellite E-UTRAN RAT type: In case of satellite E-UTRAN access, RAT types are used to distinguish different types of satellite E-UTRAN access, as defined in 3GPP TS 38.413[31]. In this version of the specification, the defined satellite E-UTRAN RAT types are “WB-E-UTRAN(LEO)”, “WB-E-UTRAN(MEO)”, “WB-E-UTRAN(GEO)”, “NB-IoT(LEO)”, “NB-IoT(MEO)”, “NB-IoT(GEO)”, “LTE-M(LEO)”, “LTE-M(MEO)” and “LTE-M(GEO)”.”

Similarly, the above shows the distinction of satellite RAT type within 3GPP (E-UTRAN access).

As part of the Cellular IoT, CIoT feature, a network e.g. 5GC, may decide to redirect an IoT device from 5GC to EPC as shown below from 3GPP TS 24.501:
“4.8.4A.2 Redirection of the UE by the core network
The network that supports CIoT optimizations can redirect a User Equipment, UE, between EPC and 5GCN as specified in subclause 5.31.3 of 3GPP TS 23.501. The network can take into account the UE's NI mode capability or S1 mode capability, the CIoT network behaviour supported and preferred by the UE or the CIoT network behaviour supported by the network to determine the redirection.

NOTE: It is assumed that the network would avoid redirecting the UE back and forth between EPC and 5GCN.

The network redirects the UE to EPC by rejecting the registration request or service request with the 5GMM cause #31 “Redirection to EPC required” as specified in subclause 5.5.1.2.5, 5.5.1.3.5 and 5.6.1.5. Upon receipt of reject message, the UE disables the NI mode capability for 3GPP access as specified in subclause 4.9.2 and enables the E-UTRA capability if it was disabled in order to move to EPC.

When there is no ongoing registration procedure or service request procedure for a UE in 5GMM-CONNECTED mode, if the Access and Mobility Management Function, AMF, determines to redirect the UE to EPC, the AMF shall initiate the generic UE configuration update procedure to indicate registration requested and release of the NI NAS signalling connection not requested as described in subclause 5.4.4. The network then redirects the UE to EPC by rejecting the registration request as specified in subclause 5.5.1.3.5.

The network that supports CIoT optimizations can also redirect a UE from EPC to 5GCN as specified in subclause 5.3.19.2 of 3GPP TS 24.301].”

Note that the EPC can also redirect a UE from EPC to 5GC using similar mechanisms as described above, noting that the description of this can be found in TS 24.301.

A UE may disable and re-enable its N1 mode based on different conditions. The following is a description from 3GPP TS 24.501 about the disabling of N1 mode of a UE:

“4.9.1General

The UE shall re-enable the NI mode capability when the UE powers off and powers on again, the USIM is removed or an entry of the “list of subscriber data” with the SNPN identity of the SNPN is updated.

4.9.2 Disabling and re-enabling of UE's N1 mode capability for 3GPP access The UE shall only disable the NI mode capability for 3GPP access when in 5GMM-IDLE mode.

When the UE is disabling the NI mode capability for 3GPP access for a PLMN not due to redirection to EPC, it should proceed as follows:
a) select an E-UTRA cell connected to EPC of the registered PLMN or a PLMN from the list of equivalent PLMNs, if the UE supports S1 mode and the UE has not disabled its E-UTRA capability as specified in 3GPP TS 24.301[15];
b) if an E-UTRA cell connected to EPC of the registered PLMN or a PLMN from the list of equivalent PLMNs cannot be found, the UE does not support S1 mode or the UE has disabled its E-UTRA capability as specified in 3GPP TS 24.301[15], the UE may select another RAT of the registered PLMN or a PLMN from the list of equivalent PLMNs that the UE supports;
c) if another RAT of the registered PLMN or a PLMN from the list of equivalent PLMNs cannot be found, then enter the state 5GMM-REGISTERED. PLMN-SEARCH or 5GMM-DEREGISTERED. PLMN-SEARCH, or the UE does not have a registered PLMN, then enter the state 5GMM-DEREGISTERED. PLMN-SEARCH and perform PLMN selection as specified in 3GPP TS 23.122[5]. If disabling of the NI mode capability for 3GPP access was not due to a UE-initiated de-registration procedure for 5GS services over 3GPP access not due to switch-off, the UE may re-enable the N1 capability for this PLMN selection. As an implementation option, if the UE does not have a registered PLMN, instead of performing PLMN selection, the UE may select another RAT of the selected PLMN if the UE has chosen a PLMN and the RAT is supported by the UE; or
d) if no other allowed PLMN and RAT combinations are available, then the UE may re-enable the NI mode capability for 3GPP access and indicate to lower layers to remain camped in NG-RAN of the registered PLMN, and may periodically scan for another PLMN and RAT combination which can provide Evolved Packet System (EPS) services or non-EPS services (if the UE supports EPS services or non-EPS services). How this periodic scanning is done, is UE implementation dependent.

When the UE is disabling the NI mode capability for 3GPP access for an SNPN, it should proceed as follows:
a) enter the state 5GMM-REGISTERED. PLMN-SEARCH or 5GMM-DEREGISTERED. PLMN-SEARCH and perform SNPN selection as specified in 3GPP TS 23.122[5]. If disabling of the NI mode capability for 3GPP access was not due to a UE-initiated de-registration procedure for 5GS services over 3GPP access not due to switch-off, the UE may re-enable the N1 capability for this SNPN selection; or
b) if no other SNPN is available, then the UE may re-enable the N1 mode capability for 3GPP access and indicate to lower layers to remain camped in NG-RAN of the registered SNPN.

When the UE is disabling the NI mode capability upon receiving cause value #31 “Redirection to EPC required” as specified in subclauses 5.5.1.2.5, 5.5.1.3.5 and 5.6.1.5, it should proceed as follows:
a) If the UE is in NB-N1 mode:
   1) if lower layers do not provide an indication that the current E-UTRA cell is connected to EPC or lower layers do not provide an indication that the current E-UTRA cell supports CIoT EPS optimizations that are supported by the UE, search for a suitable NB-IoT cell connected to EPC according to 3GPP TS 36.304[25C];
   2)if lower layers provide an indication that the current E-UTRA cell is connected to EPC and the current E-UTRA cell supports CIoT EPS optimizations that are supported by the UE, perform a core network selection to select EPC as specified in subclause 4.8.4A.1; or
   3) if lower layers cannot find a suitable NB-IoT cell connected to EPC or there is no suitable NB-IoT cell connected to EPC which supports CIoT EPS optimizations that are supported by the UE, the UE, as an implementation option, may indicate to lower layers to remain camped in E-UTRA cell connected to 5GCN, may then start an implementation-specific timer and enter the state 5GMM-REGISTERED. LIMITED-SERVICE. The UE may may re-enable the NI mode capability for 3GPP access at expiry of the implementation-specific timer, if the timer had been started, and may then proceed with the appropriate 5GMM procedure.
b) If the UE is in WB-N1 mode:
   1 ) if lower layers do not provide an indication that the current E-UTRA cell is connected to EPC or lower layers do not provide an indication that the current E-UTRA cell supports CIoT EPS optimizations that are supported by the UE, search for a suitable E-UTRA cell connected to EPC according to 3GPP TS 36.304 [25C];
   2)if lower layers provide an indication that the current E-UTRA cell is connected to EPC and the current E-UTRA cell supports CIoT EPS optimizations that are supported by the UE, then perform a core network selection to select EPC as specified in subclause 4.8.4A.1; or
   3) if lower layers cannot find a suitable E-UTRA cell connected to EPC or there is no suitable E-UTRA cell connected to EPC which supports CIoT EPS optimizations that are supported by the UE, the UE, as an implementation option, may indicate to lower layers to remain camped in E-UTRA cell connected to 5GCN, may then start an implementation-specific timer and enter the state 5GMM-REGISTERED. LIMITED-SERVICE. The UE may re-enable the NI mode capability for 3GPP access at expiry of the implementation-specific timer, if the timer had been started, and may then proceed with the appropriate 5GMM procedure.

When the UE supporting both N1 mode and S1 mode needs to stay in E-UTRA connected to EPC (e.g. due to the domain selection for UE originating sessions as specified in subclause 4.3.2), in order to prevent unintentional handover or cell reselection from E-UTRA connected to EPC to NG-RAN connected to 5GCN, the UE operating in single-registration mode shall disable the N1 mode capability for 3GPP access and:
a) shall set the N1 mode bit to “N1 mode for 3GPP access not supported” in the UE network capability IE (see 3GPP TS 24.301 [15]) of the ATTACH REQUEST message and the TRACKING AREA UPDATE REQUEST message in EPC; and
b)the UE NAS layer shall indicate the access stratum layer(s) of disabling of the NI mode capability for 3GPP access.

If the UE is required to disable the NI mode capability for 3GPP access and select E-UTRA or another RAT, and the UE is in the 5GMM-CONNECTED mode,
if the UE has a persistent PDU session, then the UE waits until the radio bearer associated with the persistent PDU session has been released;
otherwise the UE shall locally release the established NAS signalling connection;
and enter the 5GMM-IDLE mode before selecting E-UTRA or another RAT.

If the UE is disabling its NI mode capability for 3GPP access before selecting E-UTRA or another RAT, the UE shall not perform the UE-initiated de-registration procedure of subclause 5.5.2.2.

The UE shall re-enable the NI mode capability for 3GPP access when the UE performs PLMN or SNPN selection over 3GPP access, unless
disabling of the NI mode capability for 3GPP access was due to a UE-initiated de-registration procedure for 5GS services over 3GPP access not due to switch-off; or
the UE has already re-enabled the N1 mode capability for 3GPP access when performing items c) or d) above.

If the disabling of N1 mode capability for 3GPP access was due to IMS voice is not available over 3GPP access and the UE's usage setting is “voice centric”, the UE shall re-enable the NI mode capability for 3GPP access when the UE's usage setting is changed from “voice centric” to “data centric”, as specified in subclauses 4.3.3.

The UE should memorize the identity of the PLMN or SNPN where NI mode capability for 3GPP access was disabled and should use that stored information in subsequent PLMN or SNPN selections as specified in 3GPP TS 23.122.

If the disabling of NI mode capability for 3GPP access was due to successful completion of an emergency services fallback, the criteria to enable the NI mode capability again are UE implementation specific.

The UE shall disable the N1 mode capability for 3GPP access if requested by the upper layers (e.g. see subclause U. 2.2.6.4 in 3GPP TS 24.229). If the UE disabled the N1 mode capability for 3GPP access based on the request from the upper layers (e.g. see subclause U.2.2.6.4 in 3GPP TS 24.229), the criteria to re-enable the NI mode capability for 3GPP access after the completion of an emergency service are UE implementation specific.

If the NI mode capability for 3GPP access was disabled due to the UE initiated de-registration procedure for 3GPP access or for 3GPP access and non-3GPP access and the UE is operating in single-registration mode (see subclause 5.5.2.2.3), upon request of the upper layers to re-register for 5GS services over 3GPP access the UE shall enable the NI mode capability for 3GPP access again.

As an implementation option, the UE may start a timer for enabling the N1 mode capability for 3GPP access when the UE's registration attempt counter reaches 5 and the UE disables the NI mode capability for 3GPP access for cases described in subclauses 5.5.1.2.7 and 5.5.1.3.7. The UE should memorize the identity of the PLMNs where NI mode capability for 3GPP access was disabled. On expiry of this timer:
if the UE is in Iu mode or A/Gb mode and is in idle mode as specified in 3GPP TS 24.008 [13] on expiry of the timer, the UE should enable the NI mode capability for 3GPP access;
if the UE is in Iu mode and a PS signalling connection exists, but no RR connection exists, the UE may abort the PS signalling connection before enabling the NI mode capability for 3GPP access; and
if the UE is in S1 mode and is in EMM-IDLE mode as specified in 3GPP TS 24.301 [15], on expiry of the timer, the UE should enable the NI mode capability for 3GPP access.

If the UE is in Iu mode or A/Gb mode and an RR connection exists, the UE should delay enabling the NI mode capability for 3GPP access until the RR connection is released. If the UE is in S1 mode and is in EMM-CONNECTED mode as specified in 3GPP TS 24.301 [15], the UE should delay enabling the NI mode capability for 3GPP access until the NAS signalling connection in S1 mode is released.

The UE may disable the NI mode capability for currently camped PLMN or SNPN over 3GPP access (see 3GPP TS 23.122) if no network slice is available for the camped PLMN or SNPN. If the UE receives ACTIVATE DEFAULT EPS BEARER CONTEXT REQUEST message provided with S-NSSAI and the PLMN ID in the protocol configuration options IE or extended protocol configuration options IE (see subclause 6.2.2 of 3GPP TS 24.301), the UE may re-enable N1 mode capability for the corresponding PLMN.

If the UE attempts to establish an emergency PDU session in a PLMN where N1 mode capability was disabled due to the UE's registration attempt counter have reached 5, the UE may enable NI mode capability for that PLMN memorized by the UE.

NOTE: If NI mode capability is disabled due to the UE's registration attempt counter reaches 5, the value of the timer for re-enabling NI mode capability is recommended to be the same as the value of T3502 which follows the handling specified in subclause 5.3.8. If the value of T3502 is indicated as zero by the network, an implementation specific non-zero value can be used for the timer for re-enabling NI mode capability.”

Similarly, the UE may disable its S1 mode for 3GPP access as described below from 3GPP TS 24.301:

“4.9 Disabling and re-enabling of UE's NB-IoT capability

If the UE supports disabling and re-enabling of UE's NB-IoT capability and the UE in NB-S1 mode is disabling the NB-IoT capability, it should proceed as follows:
a) select E-UTRAN of the registered PLMN or a PLMN from the list of equivalent PLMNs;
b) if E-UTRAN of the registered PLMN or a PLMN from the list of equivalent PLMNs cannot be found, select another RAT (GERAN, UTRAN, or NG-RAN if the UE has not disabled its N1 mode capability for 3GPP access as specified in 3GPP TS 24.501 [54]) of the registered PLMN or a PLMN from the list of equivalent PLMNs;
c) if another RAT of the registered PLMN or a PLMN from the list of equivalent PLMNs cannot be found, or the UE does not have a registered PLMN, then perform PLMN selection as specified in 3GPP TS 23.122 [6]. As an implementation option, instead of performing PLMN selection, the UE may select another RAT of the chosen PLMN; or
d)if no other allowed PLMN and RAT combinations are available, then the UE may re-enable the NB-IoT capability and remain registered for EPS services in NB-IoT of the registered PLMN. If the UE chooses this option, then it may periodically attempt to select another PLMN and RAT combination that can provide non-EPS services. How this periodic scanning is done, is UE implementation dependent.

If the NB-IoT capability is disabled, the UE shall re-enable the NB-IoT capability when:
performing a PLMN selection unless the UE has already re-enabled the NB-IoT capability when performing bullets c) or d) above; or
the UE powers off and powers on again or the USIM is removed.

If the UE in NB-S1 mode receives an ATTACH REJECT or TRACKING AREA UPDATE REJECT message including both EMM cause #15 “no suitable cells in tracking area” and an Extended EMM cause IE with value “NB-IoT not allowed” after the UE requests access to the NB-IoT, in order to prevent unwanted cell reselection from GERAN, UTRAN, E-UTRAN or NG-RAN to NB-IoT, the UE may:
disable the NB-IoT capability:
indicate the access stratum layer(s) of disabling of the NB-IoT capability; and
memorize the identity of the PLMN where the NB-IoT capability was disabled and use that stored information in subsequent PLMN selections as specified in 3GPP TS 23.122 [6].

NOTE: The UE can only disable the NB-IoT capability when in EMM-IDLE mode.

If the UE in NB-S1 mode is required to disable the NB-IoT capability and select E-UTRAN radio access technology, and the UE is in the EMM-CONNECTED mode, the UE shall locally release the established NAS signalling connection and enter the EMM-IDLE mode before selecting E-UTRAN radio access technology.

As an implementation option, the UE may start a timer for enabling the NB-IoT capability. On expiry of this timer, the UE may enable the NB-IoT capability.”

Certain problems are encountered in the prior art. A first problem is that redirection of UE between 5GC and EPC does not consider satellite NG-RAN RAT type.

As indicated above, the UE redirection between 5GC and EPC does not consider satellite NG-RAN access type. For example, a UE may support E-TURA connected to EPC and satellite access connected to EPC. It is not clear how the 5GC should perform a redirection to EPC given a UE may support 3GPP non-satellite access and 3GPP satellite access.

Similarly, it is not clear how the EPC would behave, in terms of redirecting a UE, when policies indicate that the UE should not use E-UTRAN for CIoT over EPC i.e. whether the EPC considers the UE's capability to use satellite access connected to EPC has not been explored.

A second problem relates to UE redirection between 5GC and EPC, which does not consider satellite NG-RAN access type. For example, a UE may support E-UTRA connected to EPC and satellite access connected to EPC. It is not clear how the 5GC should perform a redirection to EPC given a UE may support 3GPP non-satellite access and 3GPP satellite access.

Similarly, it is not clear how the EPC would behave, in terms of redirecting a UE, when policies indicate that the UE should not use E-UTRAN for CIoT over EPC i.e. whether the EPC considers the UE's capability to use satellite access connected to EPC has not been explored.

According to the present invention there is provided an apparatus and method as set forth in the appended claims. Other features of the invention will be apparent from the dependent claims, and the description which follows.

According to a first aspect of the present invention, there is provided a method of operating a User Equipment, UE, communicatively coupled to a telecommunication network, PLMN, wherein If the UE supports disabling and re-enabling of UE's Narrow Band Internet of Things, NB-IoT, capability and the UE is in NB-S1 mode and is disabling the NB-IoT capability, the UE should select E-UTRAN, or if the UE supports Cellular Internet of Things, CIoT, Evolved Packet System, EPS, optimization it selects satellite E-UTRAN via “WB-E-UTRAN(LEO)”, “WB-E-UTRAN(MEO)”, or “WB-E-UTRAN(GEO)”, of the registered PLMN or a PLMN from a list of equivalent PLMNs.

In an embodiment, if E-UTRAN, or in the case of the UE which supports CIoT EPS optimization if satellite E-UTRAN via “WB-E-UTRAN(LEO)”, “WB-E-UTRAN(MEO)”, or “WB-E-UTRAN(GEO)”, of the registered PLMN or a PLMN from the list of equivalent PLMNs cannot be found, the UE selects another Radio Access Technology, RAT, of the registered PLMN or a PLMN from the list of equivalent PLMNs.

In an embodiment, the other RAT is one of GERAN, UTRAN, or NG-RAN if the UE has not disabled its N1 mode capability for 3GPP access.

According to a second aspect of the present invention, there is provided a method of operating a User Equipment, UE, communicatively coupled to a telecommunication network, PLMN, wherein if the UE is disabling N1 mode capability for 3GPP access for a PLMN not due to redirection to Evolved Packet Core, EPC, the UE selects an E-UTRA cell connected to EPC or, if the UE supports CIoT EPS optimization, it selects a satellite E-UTRA cell connected to EPC via “WB-E-UTRAN(LEO)”, “WB-E-UTRAN(MEO)”, or “WB-E-UTRAN(GEO)”, of the registered PLMN or a PLMN from the list of equivalent PLMNs, if the UE supports S1 mode and the UE has not disabled its E-UTRA capability.

In an embodiment, if: an E-UTRA cell connected to EPC or, if the UE supports CIoT EPS optimization if a satellite E-UTRA cell connected to EPC via “WB-E-UTRAN(LEO)”, “WB-E-UTRAN(MEO)”, or “WB-E-UTRAN(GEO)”, of the registered PLMN or a PLMN from the list of equivalent PLMNs cannot be found, and the UE does not support S1 mode or the UE has disabled its E-UTRA capability, the UE selects another RAT of the registered PLMN or a PLMN from the list of equivalent PLMNs that the UE supports

According to a third aspect of the present invention, there is provided a method of operating a User Equipment, UE, communicatively coupled to a telecommunication network, PLMN, wherein if the UE is in WB-N1 mode, if lower layers do not provide an indication that a current E-UTRA cell is connected to EPC or lower layers do not provide an indication that the current E-UTRA cell supports CIoT EPS optimizations that are supported by the UE, the UE searches for a suitable E-UTRA cell connected to EPC or, if the UE supports CIoT EPS optimization, the UE selects a satellite E-UTRA cell connected to EPC via “WB-E-UTRAN(LEO)”, “WB-E-UTRAN(MEO)”, or “WB-E-UTRAN(GEO)”

According to a fourth aspect of the present invention, there is provided a method of operating a User Equipment, UE, communicatively coupled to a telecommunication network, PLMN, wherein if lower layers cannot find a suitable E-UTRA cell connected to EPC, or if the lower layers cannot find a suitable satellite E-UTRA cell via “WB-E-UTRAN(LEO)”, “WB-E-UTRAN(MEO)”, or “WB-E-UTRAN(GEO)”, or there is no suitable E-UTRA cell connected to EPC, or there is no suitable satellite E-UTRA cell connected to EPC via “WB-E-UTRAN(LEO)”, “WB-E-UTRAN(MEO)”, or “WB-E-UTRAN(GEO)”, which supports CIoT EPS optimizations that are supported by the UE, the UE, indicates to lower layers to remain camped in E-UTRA cell connected to 5GCN, starts s timer and enters the state 5GMM-REGISTERED. LIMITED-SERVICE

In an embodiment, the UE re-enables N1 mode capability for 3GPP access at expiry of the timer, if the timer had been started, and then proceeds with an appropriate 5GMM procedure.

According to a fifth aspect of the present invention, there is provided apparatus arranged to perform the method of any preceding aspect.

It should be noted that mobile originated access by the UE may be due to any NAS signalling that the UE initiates or may be for sending data or requesting resources for data.

It should be noted that although the details presented herein are intended for MO attempts/requests, the same can apply for the case when the UE is paged. Hence the details can apply for a UE which receives a paging and needs to determine if it should respond to the paging or not (with the appropriate NAS procedure).

Although a few preferred embodiments of the present invention have been shown and described, it will be appreciated by those skilled in the art that various changes and modifications might be made without departing from the scope of the invention, as defined in the appended claims.

According to a first embodiment, new subscription information is defined which indicates the particular RAT type of the 3GPP access that the UE should use when being redirected to a target core network (CN). The subscription information should now contain not only the preferred CN that the UE should be redirected to but also the preferred 3GPP access RAT type that can connect to that CN.

The new subscription information can contain any of the following RAT types of the 3GPP access which support connection to the EPC: “WB-E-UTRAN(LEO)”, “WB-E-UTRAN(MEO)”, “WB-E-UTRAN(GEO)”, “NB-IoT(LEO)”, “NB-IoT(MEO)”, “NB-IoT(GEO)”, “LTE-M(LEO)”, “LTE-M(MEO)” and “LTE-M(GEO)”. Note that other as-yet unknown RAT types may also be defined in the subscription information, if introduced in the future.

Similarly, the new subscription information can contain any of the following RAT types of the 3GPP access which support connection to the 5GC: “NR(LEO)”, “NR(MEO)” and “NR(GEO)”. Note that other RAT types may also be defined in the subscription information if introduced in the future.

The subscription information should therefore indicate a preference of which RAT type to use for the UE's access of a particular CN. The preference may be in the form of priority level or any other indication. As such, the Unified Data Management, UDM/Home Subscriber Server, HSS, should provide this information to the AMF/Mobility Management Entity, MME, which then, upon redirection of the UE to a target CN, the current CN node should indicate at least one RAT type (in addition to the target CN) that should be used by the UE when accessing the target CN. The current CN may provide more than one RAT type based on some priority order or may provide a set of RAT types with no priority order which may mean that the UE selects a RAT type based on its preferences, pre-configuration, randomly or based on implementation.

When selecting a CN to redirect the UE to, the current CN node (e.g. MME or AMF) should also select at least one preferred RAT type and indicate the preferred RAT type to the UE in addition to the target CN type. Note that the current CN node may indicate a priority level with each RAT type, where the UE may use this priority level as an indication of which RAT type should be used to access a target CN node, where the UE may start with the most preferred RAT type and move to the next one in case that RAT type has no coverage. The preference determined by the UE may be explicitly received at the UE e.g. from the source CN, or preconfigured in the UE, or based on local preferences or policies in the UE.

It should be noted that one CN type may perform intra-CN but inter-RAT redirection based on subscription information (which may be updated to trigger such a redirection). For example, the EPC (e.g. MME) may redirect the UE from EPC CN and (WB or NB) E-TRAN to EPC CN and WB-E-UTRAN(LEO). Note that this is just an example where other possibilities can be used, noting that at least one target RAT type may be provided optionally with a priority level.

When the UE receives a NAS message indicating a redirection to a CN and at least one RAT type, then the UE should attempt to use the indicated RAT type to access the target CN optionally based on a priority level associated with the RAT type e.g. where the highest priority level associated with a RAT type will mean that the UE should first select or try to use that RAT type to access the target CN. Alternatively, the UE may use preconfigured priorities to use a particular RAT type.

In one embodiment, the source CN may receive updated subscription information based on which the UE redirection should occur e.g. either to a completely new CN and optionally a particular RAT type connecting to that CN (e.g. inter-CN optionally with inter-RAT), or to the same CN but a different RAT type (e.g. intra-CN inter-RAT redirection).

For any of the above, the CN may use any NAS message to perform the redirection e.g. Service Reject, Registration Reject, Tracking Area Update Reject, Attach Reject, etc.

In order to enable the above, one alternative is that a new information element (IE) is defined to communicate the redirection details or options in terms of CN and/or RAT type. Alternatively, existing IEs may be used where new bits may be introduced to achieve this.

Upon reception of a UE, optionally from a CN node (e.g. MME or AMF), of a NAS message (either in S1 mode or N1 mode, or any other mode) where the NAS message indicates a redirection to a target CN and optionally a RAT type to use, the UE should attempt to access the indicated CN using an optionally indicated RAT type, where optionally this selected or indicated RAT type may be based on a certain priority that is either received at the UE (e.g. from the network) or based on local UE configurations or policies.

In a second embodiment, disabling of UE's NAS (S1 or N1) mode may be RAT specific.

The network may specifically or explicitly indicate the RAT type for which a UE's NAS mode—S1 mode or N1 mode—should be disabled.

Currently, the 5GS network (e.g. the AMF) may reject a UE's NAS message with cause value #27 “N1 mode not allowed” which would disable the UE's N1 mode over the 3GPP access. However, this is not a fine granularity in terms of disabling N1 mode.

Therefore, the network may indicate the specific RAT type(s) for which a particular mode should be deactivated, where for example the network may indicate any combination of the following (i.e. one or more):
>Disable N1 mode for 3GPP access (non-satellite)
>Disable N1 mode for 3GPP satellite access-All RATs
>Disable N1 mode for 3GPP satellite access-“NR(LEO)”
>Disable N1 mode for 3GPP satellite access-“NR(MEO)”
>Disable N1 ode for 3GPP satellite access-“NR(GEO)”
>Disable N1 mode for all 3GPP RAT (satellite and non-satellite)

Note that the above may be amended to also include new categories or RAT types that can be WB (wideband) or NB (narrowband) and as such any combination of the above may be defined with WB or NB e.g. WB-NR(GEO), NB-NR(GEO), etc

The same also apply for EPS in which the network (e.g. MME) may indicate specific RAT(s) for which S1 mode should be disabled. As such, the following may be indicated by the network using any combination:
>Disable S1 mode for 3GPP access (non-satellite)
>Disable S1 mode for 3GPP satellite access-All RATs
>Disable S1 mode for 3GPP satellite access-WB-E-UTRAN(LEO)
>Disable S1 mode for 3GPP satellite access-WB-E-UTRAN(MEO)
>Disable S1 mode for 3GPP satellite access-WB-E-UTRAN(GEO)
>Disable S1 mode for 3GPP satellite access-NB-IoT(LEO)
>Disable S1 mode for 3GPP satellite access-NB-IoT(MEO)
>Disable S1 mode for 3GPP satellite access-NB-IoT(GEO)
>Disable N1 mode for all 3GPP RAT (satellite and non-satellite) Note that new IEs or bit positions in existing IEs can be used to communicate any of the above. The network (AMF or MME) may include any of the above indications in any new or existing NAS message (e.g. as those previously listed herein).

In one alternative, when the UE receives any cause value (either in S1 mode or N1 mode) to disable its NAS mode (S1 or N1), where this may be any new or existing cause value, the UE may take any of the following actions:
>If the cause value is received on a satellite RAT type (e.g. any satellite RAT type), then the UE will disable its NAS mode (S1 or N1) only for the specific RAT type over which the cause value was received
>If the cause value is received on a satellite RAT type (e.g. any satellite RAT type), the UE may consider that its NAS mode (S1 or N1) should be disabled for all satellite RAT types, but not for the non-satellite 3GPP RAT type. As such, the UE may hence disable its NAS mode (S1 or N1) for all satellite RAT types but not for non-satellite RAT types. Optionally, the UE may disable its NAS mode (S1 or N1) for a set (either pre-known or explicitly indicated by the network) of satellite RAT types (e.g. for all combinations of NB satellite RAT types but not WB satellite RAT types, or all WB satellite RAT types but not NB satellite RAT types, or all Leo RAT types only, or all Geo RAT types only, or GEO and MEO RAT types but not LEO, etc. Any other combination may also be defined and these should be considered as examples only.

In another alternative, when the UE (either in S1 mode or N1 mode) disables its NAS mode (S1 or N1), where this may be due to abnormal failure or lower layer failure resulting attach/registration attempt counter reaching max value, the UE may take any of the following actions:
>If the attach or registration attempt counter reached max value on a satellite RAT type (e.g. any satellite RAT type), then the UE will disable its NAS mode (S1 or N1) only for the specific RAT type.
>If the attach or registration attempt counter reached max value on a satellite RAT type (e.g. any satellite RAT type), the UE may consider that its NAS mode (S1 or N1) should be disabled for all satellite RAT types, but not for the non-satellite 3GPP RAT type. As such, the UE may hence disable its NAS mode (S1 or N1) for all satellite RAT types but not for non-satellite RAT types. Optionally, the UE may disable its NAS mode (S1 or N1) for a set (either pre-known or explicitly indicated by the network) of satellite RAT types (e.g. for all combinations of NB satellite RAT types but not WB satellite RAT types, or all WB satellite RAT types but not NB satellite RAT types, or all Leo RAT types only, or all Geo RAT types only, or GEO and MEO RAT types but not LEO, etc. Any other combination may also be defined, and these should be considered as examples only.

For any of the above, the UE may re-enable any of its modes that has/have been disabled when e.g. the UE needs to place an emergency service or request a session for emergency service (e.g. new PDN connection or new PDU session for emergency), or after a timer expires where the UE may have started the timer when a particular mode was disabled as set out above, etc, or when the UE gets an explicit indication from the network to re-enable any particular mode which the network may have previously requested/indicated the UE to disable.

A further embodiment relates to updating the UE behaviour after receiving an indication to disable its NAS mode due to redirection to a target CN.

The following refers to solutions to update the UE behaviour when disabling its NAS mode which in the prior art does not consider satellite access or satellite RAT as a potential target RAT for use by the UE.

When the UE in N1 mode receives the cause value “#31 Redirection to EPC required”, the UE currently disables its N1 mode for 5GC but does not disable its E-UTRA capability for connecting to EPC. Additionally, the UE should maintain its N1mode enabled for 3GPP satellite RAT for connecting to 5GC. However, the UE should optionally not use N 1 mode over 3GPP satellite RAT unless the UE cannot find any suitable cell which provides CIoT optimization in S1 mode or N1 mode, or when the UE needs to place an emergency call.

When a UE in N1 mode is redirected to EPC (i.e. S1 mode), the UE may also search for a suitable satellite cell which connects to EPC via any satellite RAT (assuming the UE supports IoT optimizations over any satellite RAT). The UE may search for a suitable NB-IoT satellite cell or a WB satellite cell for connecting to EPC. This is because the prior art UE behaviour does not consider satellite cells as target cells that the UE can use to connect to EPC.

The following shows an example of how the prior art behaviour can be amended to adopt the solutions set out herein, where the amendment is shown as underlined text for clarity:
“When the UE is disabling the NI mode capability upon receiving cause value #31 “Redirection to EPC required” as specified in subclauses 5.5.1.2.5, 5.5.1.3.5 and 5.6.1.5, it should proceed as follows:
a) If the UE is in NB-N1 mode:
   1) if lower layers do not provide an indication that the current E-UTRA cell is connected to EPC or lower layers do not provide an indication that the current E-UTRA cell supports CIoT EPS optimizations that are supported by the UE, search for a suitable NB-IoT cell connected to EPC or search for a suitable satellite NB-IoT cell connected to EPC according to 3GPP TS 36.304 [25 C];
   2) if lower layers provide an indication that the current E-UTRA cell is connected to EPC and the current E-UTRA cell supports CIoT EPS optimizations that are supported by the UE, perform a core network selection to select EPC as specified in subclause 4.8.4A.1; or
   3) if lower layers cannot find a suitable NB-IoT cell or cannot find a suitable satellite NB-IoT cell connected to EPC or there is no suitable NB-IoT cell connected to EPC which supports CIoT EPS optimizations that are supported by the UE or there is no suitable satellite NB-IoT cell connected to EPC which supports CIoT EPS optimizations that are supported by the UE, the UE, as an implementation option, may indicate to lower layers to remain camped in E-UTRA cell connected to 5GCN, may then start an implementation-specific timer and enter the state 5GMM-REGISTERED. LIMITED-SERVICE. The UE may may re-enable the NI mode capability for 3GPP access at expiry of the implementation-specific timer, if the timer had been started, and may then proceed with the appropriate 5GMM procedure. Optionally, the UE may immediately (or after the expiry of a timer) attempt to access the 5GC over a 3GPP satellite cell (or 3GPP satellite RAT) which connects to 5GC.
b) If the UE is in WB-NI mode:
   1 ) if lower layers do not provide an indication that the current E-UTRA cell is connected to EPC or lower layers do not provide an indication that the current E-UTRA cell supports CIoT EPS optimizations that are supported by the UE, search for a suitable E-UTRA cell connected to EPC or search for a suitable (WB-IoT or WB) satellite cell connected to EPC according to 3GPP TS 36.304 [25C];
   2) if lower layers provide an indication that the current E-UTRA cell is connected to EPC and the current E-UTRA cell supports CIoT EPS optimizations that are supported by the UE, then perform a core network selection to select EPC as specified in subclause 4.8.4A.1; or
   3) if lower layers cannot find a suitable E-UTRA cell or cannot find a suitable (WB-IoT or WB) satellite cell connected to EPC or there is no suitable E-UTRA cell connected to EPC which supports CIoT EPS optimizations that are supported by the UE or there is no suitable satellite (WB-IoT or WB) cell connected to EPC which supports CIoT EPS optimizations that are supported by the UE, the UE, as an implementation option, may indicate to lower layers to remain camped in E-UTRA cell connected to 5GCN, may then start an implementation-specific timer and enter the state 5GMM-REGISTERED. LIMITED-SERVICE. The UE may re-enable the NI mode capability for 3GPP access at expiry of the implementation-specific timer, if the timer had been started, and may then proceed with the appropriate 5GMM procedure. Optionally, the UE may immediately (or after the expiry of a timer) attempt to access the 5GC over a 3GPP satellite cell (or 3GPP satellite RAT) which connects to 5GC.”

Similarly, the following changes can be implemented for the case when the UE disables N1 mode but not due to redirection to EPC, where the changes are show with underlined text.

“4.9.2 Disabling and re-enabling of UE's N1 mode capability for 3GPP access The UE shall only disable the N1 mode capability for 3GPP access when in 5GMM-IDLE mode.

When the UE is disabling the N1 mode capability for 3GPP access for a PLMN not due to redirection to EPC, it should proceed as follows:
a)select an E-UTRA cell connected to EPC or a satellite E-UTRA cell connected to EPC of the registered PLMN or a PLMN from the list of equivalent PLMNs, if the UE supports S1 mode and the UE has not disabled its E-UTRA capability as specified in 3GPP TS 24.301;
b) if an E-UTRA cell connected to EPC or a satellite E-UTRA cell connected to EPC of the registered PLMN or a PLMN from the list of equivalent PLMNs cannot be found, the UE does not support S1 mode or the UE has disabled its E-UTRA capability as specified in 3GPP TS 24.301, the UE may select another RAT of the registered PLMN or a PLMN from the list of equivalent PLMNs that the UE supports;
c) if another RAT of the registered PLMN or a PLMN from the list of equivalent PLMNs cannot be found, then enter the state 5GMM-REGISTERED. PLMN-SEARCH or 5GMM-DEREGISTERED. PLMN-SEARCH, or the UE does not have a registered PLMN, then enter the state 5GMM-DEREGISTERED. PLMN-SEARCH and perform PLMN selection as specified in 3GPP TS 23.122[5]. If disabling of the NI mode capability for 3GPP access was not due to a UE-initiated de-registration procedure for 5GS services over 3GPP access not due to switch-off, the UE may re-enable the NI capability for this PLMN selection. As an implementation option, if the UE does not have a registered PLMN, instead of performing PLMN selection, the UE may select another RAT of the selected PLMN if the UE has chosen a PLMN and the RAT is supported by the UE; or
d) if no other allowed PLMN and RAT combinations are available, then the UE may re-enable the NI mode capability for 3GPP access and indicate to lower layers to remain camped in NG-RAN of the registered PLMN, and may periodically scan for another PLMN and RAT combination which can provide EPS services or non-EPS services (if the UE supports EPS services or non-EPS services). How this periodic scanning is done, is UE implementation dependent.

When the UE is disabling the NI mode capability for 3GPP access for an SNPN, it should proceed as follows:
a) enter the state 5GMM-REGISTERED. PLMN-SEARCH or 5GMM-DEREGISTERED. PLMN-SEARCH and perform SNPN selection as specified in 3GPP TS 23.122. If disabling of the NI mode capability for 3GPP access was not due to a UE-initiated de-registration procedure for 5GS services over 3GPP access not due to switch-off, the UE may re-enable the NI capability for this SNPN selection; or
b) if no other SNPN is available, then the UE may re-enable the N1 mode capability for 3GPP access and indicate to lower layers to remain camped in NG-RAN of the registered SNPN.”

It should be noted that all the details set out herein may apply in any combination.

For example, with the text shown above, the UE may disable N1 mode for 3GPP access where the RAT type is not satellite if the 5GMM cause value was received over non-satellite 3GPP RAT type. As such, the previous embodiments may also be applicable above. Alternatively, disabling N1 mode may also lead to the disabling of N1 mode for certain or all 3GPP satellite access/RAT types.

The following solution provides for a UE in S1 mode which determines to disable S1 mode where the proposed change to the standard specification text is shown as underlined text:
“4.9 Disabling and re-enabling of UE's NB-IoT capability

If the UE supports disabling and re-enabling of UE's NB-IoT capability and the UE in NB-S1 mode is disabling the NB-IoT capability, it should proceed as follows:
a) select E-UTRAN or satellite E-UTRAN cell of the registered PLMN or a PLMN from the list of equivalent PLMNs;
b) if E-UTRAN of the registered PLMN or a PLMN from the list of equivalent PLMNs cannot be found, select another RAT (GERAN, UTRAN, or NG-RAN or satellite NG-RAN if the UE has not disabled its NI mode capability for 3GPP access as specified in 3GPP TS 24.501 [54]) of the registered PLMN or a PLMN from the list of equivalent PLMNs;
c) if another RAT of the registered PLMN or a PLMN from the list of equivalent PLMNs cannot be found, or the UE does not have a registered PLMN, then perform PLMN selection as specified in 3GPP TS 23.122 [6]. As an implementation option, instead of performing PLMN selection, the UE may select another RAT of the chosen PLMN which may include a satellite RAT; or
d) if no other allowed PLMN and RAT combinations are available, then the UE may re-enable the NB-IoT capability or the satellite NB-IoT capability and remain registered for EPS services in NB-IoT of the registered PLMN. If the UE chooses this option, then it may periodically attempt to select another PLMN and RAT combination that can provide non-EPS services. How this periodic scanning is done, is UE implementation dependent.

If the NB-IoT capability is disabled, the UE shall re-enable the NB-IoT capability when:
performing a PLMN selection unless the UE has already re-enabled the NB-IoT capability when performing bullets c) or d) above; or
the UE powers off and powers on again or the USIM is removed.

If the UE in NB-S1 mode receives an ATTACH REJECT or TRACKING AREA UPDATE REJECT message including both EMM cause #15 “no suitable cells in tracking area” and an Extended EMM cause IE with value “NB-IoT not allowed” after the UE requests access to the NB-IoT, in order to prevent unwanted cell reselection from GERAN, UTRAN, E-UTRAN or NG-RAN to NB-IoT, the UE may:
disable the NB-IoT capability:
indicate the access stratum layer(s) of disabling of the NB-IoT capability; and
memorize the identity of the PLMN where the NB-IoT capability was disabled and use that stored information in subsequent PLMN selections as specified in 3GPP TS 23.122 [6].

NOTE: The UE can only disable the NB-IoT capability when in EMM-IDLE mode.

If the UE in NB-S1 mode is required to disable the NB-IoT capability and select E-UTRAN radio access technology, and the UE is in the EMM-CONNECTED mode, the UE shall locally release the established NAS signalling connection and enter the EMM-IDLE mode before selecting E-UTRAN radio access technology.

As an implementation option, the UE may start a timer for enabling the NB-IoT capability. On expiry of this timer, the UE may enable the NB-IoT capability.”

Note that when the UE disables any capability in S1 mode, it may do so for the specific access type or RAT type over which the cause value (which leads to disabling of the capability) was received. As such, details of the previous embodiment(s) would apply above as well.

The following changes are proposed to the section 4.5 in TS 24.301:
4.5 Disabling and re-enabling of UE's E-UTRA capability

The UE shall only disable the E-UTRA capability or satellite E-UTRA capability when in EMM-IDLE mode over the specific or particular access type.

When the UE supports both NI mode and S1 mode then the UE's capability to access the 5GCN via E-UTRA shall not be affected, if the UE's E-UTRA capability is disabled or enabled.

When the UE is disabling the E-UTRA capability not due to redirection to 5GCN required, it should proceed as follows:
a) select another RAT (GERAN, UTRAN, satellite E-UTRAN RAT (which may be any combination of “WB-E-UTRAN(LEO)”, “WB-E-UTRAN(MEO)”, “WB-E-UTRAN(GEO)”, “NB-IoT(LEO)”, “NB-IoT(MEO)”, “NB-IoT(GEO)”, “LTE-M(LEO)”, “LTE-M(MEO)” and “LTE-M(GEO)”, or any other new satellite RATs that may be defined in the future) or NG-RAN if the UE has not disabled its NI mode capability for 3GPP access as specified in 3GPP TS 24.501 [54]) of the registered PLMN or a PLMN from the list of equivalent PLMNs, or satellite NG-RAN (which may include any combination of “NR(LEO)”, “NR(MEO)” and “NR(GEO)”, or any other new satellite RATs that may be defined in the future) if the UE has not disabled its NI mode capability for satellite 3GPP access as specified in 3GPP TS 24.501 [54]) of the registered PLMN or a PLMN from the list of equivalent PLMNs;
b) if another RAT (which may include satellite RAT) of the registered PLMN or a PLMN from the list of equivalent PLMNs cannot be found, or the UE does not have a registered PLMN, then perform PLMN selection as specified in 3GPP TS 23.122 [6].

As an implementation option, instead of performing PLMN selection, the UE may select another RAT (which may include satellite RAT) of the chosen PLMN. If disabling of E-UTRA capability was not due to UE initiated detach procedure for EPS services only, the UE may re-enable the E-UTRA capability for this PLMN selection; or
c) if no other allowed PLMN and RAT combinations are available, then the UE may re-enable the E-UTRA capability and remain registered for EPS services in E-UTRAN or satellite E-UTRAN of the registered PLMN. If the UE chooses this option, then it may periodically attempt to select another PLMN and RAT combination that can provide non-EPS services. How this periodic scanning is done, is UE implementation dependent.

When the UE is disabling the E-UTRA capability upon receiving reject cause #31 “Redirection to 5GCN required” as specified in clauses 5.5.1.2.5, 5.5.1.3.5, 5.5.3.2.5, 5.5.3.3.5 and 5.6.1.5, it should proceed as follows:
i) If the UE is in NB-S1 mode:
1) if lower layers do not provide an indication that the current E-UTRA cell is connected to 5GCN or lower layers do not provide an indication that the current E-UTRA cell supports CIoT 5GS optimizations that are supported by the UE, search for a suitable NB-IoT cell connected to 5GCN according to 3GPP TS 36.304 [21];
2) if lower layers provide an indication that the current E-UTRA cell is connected to 5GCN and the current E-UTRA cell supports CIoT 5GS optimizations that are supported by the UE then perform a core network selection to select 5GCN as specified in 3GPP TS 24.501[54] clause 4.8.4A.1; or
3) if lower layers cannot find a suitable NB-IoT cell connected to 5GCN or there is no suitable NB-IoT cell connected to 5GCN which supports CIoT 5GS optimizations that are supported by the UE, the UE, as an implementation option, may indicate to lower layers to remain camped in E-UTRA cell connected to EPC, may then start an implementation-specific timer and enter the state EMM-REGISTERED. LIMITED-SERVICE the UE may re-enable the E-UTRA capability for 3GPP access at expiry of the implementation-specific timer, if the timer had been started, and may then, proceed with the appropriate EMM procedure.
ii) If the UE is in WB-S1 mode:
1) if lower layers do not provide an indication that the current E-UTRA cell is connected to 5GCN or lower layers do not provide an indication that the current E-UTRA cell supports CIoT 5GS optimizations that are supported by the UE, search for a suitable E-UTRA cell connected to 5GCN according to 3GPP TS 36.304[21];
2)if lower layers provide an indication that the current E-UTRA cell is connected to 5GCN and the current E-UTRA cell supports CIoT 5GS optimizations that are supported by the UE, then perform a core network selection to select 5GCN as specified in 3GPP TS 24.501 [54] clause 4.8.4A.1; or 3)if lower layers cannot find a suitable E-UTRA cell connected to 5GCN or there is no suitable E-UTRA cell connected to 5GCN which supports CIoT 5GS optimizations that are supported by the UE, the UE, as an implementation option, may indicate to lower layers to remain camped in E-UTRA cell connected to EPC, may then start an implementation-specific timer and enter the state EMM-REGISTERED. LIMITED-SERVICE the UE may re-enable the E-UTRA capability for 3GPP access at expiry of the implementation-specific timer, if the timer had been started, and may then, proceed with the appropriate EMM procedure.

The UE shall re-enable the E-UTRA capability when performing a PLMN selection unless:
the disabling of E-UTRA capability was due to UE initiated detach procedure for EPS services only; or
the UE has already re-enabled the E-UTRA capability when performing bullets b) or c) above.

If due to handover, the UE moves to a new PLMN in A/Gb, Iu, or NI mode which is not in the list of equivalent PLMNs and not a PLMN memorized by the UE for which E-UTRA capability was disabled, and the disabling of E-UTRA capability was not due to UE initiated detach procedure for EPS services only, the UE shall re-enable the E-UTRA capability after the RR/RRC connection is released.

If UE that has disabled its E-UTRA capability due to IMS voice not available and CS fallback not available re-enables it when PLMN selection is performed, then it should memorize the identity of the PLMNs where E-UTRA capability was disabled and use that stored information in subsequent PLMN selections as specified in 3GPP TS 23.122 [6].

The UE may support “E-UTRA Disabling for EMM cause #15” and implement the following behaviour:
if the “E-UTRA Disabling Allowed for EMM cause #15” parameter as specified in 3GPP TS 24.368 [15 A] or 3GPP TS 31.102 [17] is present and set to enabled; and
if the UE receives an ATTACH REJECT or TRACKING AREA UPDATE REJECT message including both EMM cause #15 “no suitable cells in tracking area” and an Extended EMM cause IE with value “E-UTRAN not allowed”;

then the UE shall disable the E-UTRA capability, memorize the identity of the PLMN where the E-UTRA capability was disabled and use that stored information in subsequent PLMN selections as specified in 3GPP TS 23.122 [6].

When the UE supporting the A/Gb and/or Iu mode together with the S1 mode needs to stay in A/Gb or Iu mode, in order to prevent unwanted handover or cell reselection from UTRAN/GERAN to E-UTRAN, the UE shall disable the E-UTRA capability and:
The UE shall not set the E-UTRA support bits of the MS Radio Access capability IE (see 3GPP TS 24.008 [13], clause 10.5.5.12a), the E-UTRA support bits of Mobile Station Classmark 3 IE (see 3GPP TS 24.008 [13], clause 10.5.1.7), the PS inter-RAT HO from GERAN to E-UTRAN S1 mode capability bit and the ISR support bit of the MS network capability IE (see 3GPP TS 24.008 [13], clause 10.5.5.12) in the ATTACH REQUEST message and the ROUTING AREA UPDATE REQUEST message after it selects GERAN or UTRAN;
the UE shall use the same value of the EPC capability bit of the MS network capability IE (see 3GPP TS 24.008 [13], clause 10.5.5.12) in the ATTACH REQUEST message and the ROUTING AREA UPDATE REQUEST message; and
the UE NAS layer shall indicate the access stratum layer(s) of disabling of the E-UTRA capability.

When the UE supporting NI mode together with S1 mode needs to stay in NI mode, in order to prevent unwanted handover or cell reselection from NG-RAN to E-UTRAN, the UE shall disable the E-UTRA capability and:
the UE shall set the S1 mode bit to “S1 mode not supported” in the 5GMM Capability IE of the REGISTRATION REQUEST message (see 3GPP TS 24.501 [54]);
the UE shall not include the S1 UE network capability IE in the REGISTRATION REQUEST message (see 3GPP TS 24.501 [54]); and
the UE NAS layer shall indicate the access stratum layer(s) of disabling of the E-UTRA capability.

If the UE is disabling its E-UTRA capability before selecting to GERAN, UTRAN or NG-RAN radio access technology, the UE shall not perform the detach procedure of clause 5.5.2.1.

If the UE is required to disable the E-UTRA capability and select GERAN, UTRAN, satellite E-UTRAN (which may be any of the previously listed satellite RATs), satellite NG-RAN (which may be any of the previously listed satellite RATs) or NG-RAN radio access technology, and the UE is in the EMM-CONNECTED mode:
if the UE has a persistent EPS bearer context and the ongoing procedure is not a detach procedure, then the UE shall wait until the radio bearer associated with the persistent EPS bearer context has been released;
otherwise, the UE shall locally release the established NAS signalling connection and enter the EMM-IDLE mode before selecting GERAN, UTRAN, satellite E-UTRAN (which may be any of the previously listed satellite RATs), satellite NG-RAN (which may be any of the previously listed satellite RATs) or NG-RAN radio access technology.

If the E-UTRA capability was disabled due to the attempt to select GERAN or UTRAN radio access technology progressing the CS emergency call establishment (see clause 4.3.1), the criteria to enable the E-UTRA capability again is UE implementation specific.

If the E-UTRA capability was disabled due to the UE initiated detach procedure for EPS services only (see clause 5.5.2.2.2), upon request of the upper layers to re-attach for EPS services the UE shall enable the E-UTRA capability again. If the E-UTRA capability was disabled due to receipt of EMM cause #14 “EPS services not allowed in this PLMN”, then the UE shall enable the E-UTRA capability when the UE powers off and powers on again or the USIM is removed. If E-UTRA capability was disabled for any other reason, the UE shall enable the E-UTRA capability in the following cases:
the UE mode of operation changes from CS/PS mode 1 of operation to CS/PS mode 2 of operation;
the UE mode of operation changes from PS mode 1 of operation to PS mode 2 of operation; or
the UE powers off and powers on again or the USIM is removed;

As an implementation option, the UE may start a timer for enabling E-UTRA when the UE's attach attempt counter or tracking area updating attempt counter reaches 5 and the UE disables E-UTRA capability for cases described in clauses 5.5.1.2.6, 5.5.1.3.4.3, 5.5.1.3.6, 5.5.3.2.6, 5.5.3.3.4.3 and 5.5.3.3.6. The UE should memorize the identity of the PLMNs and optionally the RAT where E-UTRA capability were disabled. On expiry of this timer:
if the UE is in Iu mode or A/Gb mode and is in idle mode as specified in 3GPP TS 24.008 [13] on expiry of the timer, the UE should enable the E-UTRA capability;
if the UE is in Iu mode or A/Gb mode and an RR connection exists, the UE shall delay enabling E-UTRA capability until the RR connection is released;
if the UE is in Iu mode and a PS signalling connection exists but no RR connection exists, the UE may abort the PS signalling connection before enabling E-UTRA capability;
if the UE is in NI mode and is in 5GMM-IDLE mode as specified in 3GPP TS 24.501 [54], on expiry of the timer, the UE should enable the E-UTRA capability; and
if the UE is in NI mode and is in 5GMM-CONNECTED mode as specified in 3GPP TS 24.501 [54], on expiry of the timer, the UE shall delay enabling the E-UTRA capability until the NI NAS signalling connection is released.

If the UE attempts to establish an emergency bearer service or to access RLOS in a PLMN where the E-UTRA capability was disabled due to the UE's attach attempt counter or tracking area updating attempt counter have reached 5, the UE may enable the E-UTRA capability for that PLMN memorized by the UE.

The UE may support being configured for No E-UTRA Disabling In 5GS (see 3GPP TS 24.368 [50] or 3GPP TS 31.102 [17]). If the UE supports being configured for No E-UTRA Disabling in 5GS, No E-UTRA Disabling In 5GS is enabled if the corresponding configuration parameter is present and set to enabled. Otherwise, No E-UTRA Disabling In 5GS is disabled. If No E-UTRA Disabling In 5GS is enabled at the UE and the UE selects an NG-RAN cell in a PLMN where the E-UTRA capability was disabled due to the UE's attach attempt counter or tracking area updating attempt counter having reached 5, the UE shall enable the E-UTRA capability for that PLMN.

For other cases, it is up to the UE implementation when to enable the E-UTRA capability.

NOTE: If the UE is not operating in CS/PS mode 1 operation, the value of the timer for enabling E-UTRA capability is recommended to be not larger than the default value of T3402.

The following changes may be applicable to any section or specification i.e. they are not necessarily for a particular section of the specification.

For all of the above, when the UE disables E-UTRA capability (optionally in S1 mode), the UE has to consider its current RAT type based where this capability is being disabled. The UE may take different actions accordingly.

For example, if the UE was using a non-satellite E-UTRA cell when it disables its E-UTRA capability, then the UE considers the E-UTRA capability to be disabled for 3GPP E-UTRA access/RAT excluding satellite E-UTRA access/RAT and hence the UE may behave as described using any of the above.

For example, if the UE was using a satellite E-UTRA cell when it disables its E-UTRA capability, then the UE considers the E-UTRA capability to be disabled for satellite E-UTRA access/RAT excluding 3GPP (non-satellite) E-UTRA access/RAT and hence when the UE needs to select a different RAT in E-UTRA, then the UE can select 3GPP E-UTRA access/RAT but excluding the satellite E-UTRA access/RAT i.e. the UE does not consider the satellite E-UTRA access/RAT for (re-)selecting a cell of any PLMN but only considers 3GPP E-UTRA access while doing so. The UE may optionally consider the satellite RAT for N1 mode if N1 mode capability is not disabled.

Alternatively, disabling of satellite S1 mode capability may be considered to be specific to the particular satellite access/RAT that the UE is on when the S1 mode capability is disabled. Therefore the UE may consider the S1 mode capability to still be enabled on other satellite access/RAT as applicable (except if the UE has already disabled such satellite access/RAT types specifically).

Alternatively, disabling of satellite S1 mode capability may be considered to be specific to the particular PLMN and satellite access/RAT that the UE is on when the S1 mode capability is disabled. Therefore the UE may consider the S1 mode capability to still be enabled on other PLMNs and satellite access/RAT as applicable (except if the UE has already disabled such satellite access/RAT types specifically for such PLMNs).

If the UE has disabled its capability for E-UTRA access/RAT (on 3GPP access which excludes satellite E-UTRA) optionally in S1 mode, and later also the UE disables its capability for satellite E-UTRA access/RAT optionally in S1 mode, then the UE should not consider to use any E-UTRA capability (optionally in S1 mode) for 3GPP access or satellite 3GPP access, unless the UE has a trigger or condition for re-enabling E-UTRA capability (optionally in S1 mode).

If the UE has disabled its capability for satellite E-UTRA access/RAT (optionally in S1 mode), and later also the UE disables its capability (optionally in S1 mode) for E-UTRA access/RAT (on 3GPP access which excludes satellite E-UTRA), then the UE should not consider to use any E-UTRA capability (optionally in S1 mode) for 3GPP access or satellite 3GPP access, unless the UE has a trigger or condition for re-enabling E-UTRA capability (optionally in S1 mode).

When the UE disables its N1 capability, the UE has to consider its current RAT type based where this capability is being disabled. The UE may take different actions accordingly.

For example, if the UE was using N1 mode on an NG-RAN cell (which is a non-satellite NG-RAN cell) when it disables its N1 mode capability, then the UE considers the N1 mode capability to be disabled for NG-RAN access/RAT excluding satellite NG-RAN access/RAT. As such, when the UE attempts to (re-)select any cell of any PLMN, the UE may consider to use N1 mode capability over any satellite NG-RAN cell.

For example, if the UE was using N1 mode on a satellite NG-RAN cell (or access/ RAT) when it disables its N1 mode capability, then the UE considers the N1 mode capability to be disabled for satellite NG-RAN access/RAT excluding the 3GPP NG-RAN access/RAT. As such, when the UE attempts to (re-)select any cell of any PLMN, the UE may consider to use N1 mode capability over any 3GPP NG-RAN cell (except for satellite NG-RAN cell or access/RAT).

Alternatively, disabling of satellite N1 mode capability may be considered to be specific to the particular satellite access/RAT that the UE is on when the N1 mode capability is disabled. Therefore, the UE may consider the N1 mode capability to still be enabled on other satellite access/RAT as applicable (except if the UE has already disabled such satellite access/RAT types specifically).

Alternatively, disabling of satellite N1 mode capability may be considered specific to the particular PLMN and satellite access/RAT that the UE is on when the N1 mode capability is disabled. Therefore the UE may consider the N1 mode capability to still be enabled on other PLMNs and satellite access/RAT as applicable (except if the UE has already disabled such satellite access/RAT types specifically for such PLMNs).

If the UE has disabled its capability for N1 mode (on 3GPP access which excludes satellite E-UTRA), and later also the UE disables its capability for satellite N1 mode, then the UE should not consider to use any N1 mode capability for 3GPP access or satellite 3GPP access, unless the UE has a trigger or condition for re-enabling N1 mode capability. Optionally this applies when N1 mode capability over satellite is considered to be covering all satellite access/RAT types. Alternatively, if this is not the case, the disabling N1 mode capability over one satellite access/RAT type can allow the UE to use N1 mode capability over another satellite access/RAT if N1 mode capability is not disabled over that satellite access/RAT type.

If the UE has disabled its capability for N1 mode capability for satellite, and later also the UE disables its N1 mode capability non-satellite NG-RAN access/RAT (on 3GPP access which excludes satellite NG-RAN), then the UE should not consider to use N1 mode capability for 3GPP access or satellite 3GPP access (e.g. satellite NG-RAN), unless the UE has a trigger or condition for re-enabling its capability for N1 mode.

If the UE has disabled its capability for satellite E-UTRA access/RAT (optionally in S1 mode), and later also the UE disables its capability (optionally in S1 mode) for E-UTRA access/RAT (on 3GPP access which excludes satellite E-UTRA), then the UE should not consider to use any E-UTRA capability (optionally in S1 mode) for 3GPP access or satellite 3GPP access, unless the UE has a trigger or condition for re-enabling E-UTRA capability (optionally in S1 mode).

Note that the above combinations of RAT and/or access types are examples only and should not be considered as limitations, but examples only.

For all of the solutions described herein, the solutions can apply in any order or combination. Moreover, the solutions may be applicable to the different systems such as, but not limited to, 4G, 5G, 6G, etc.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

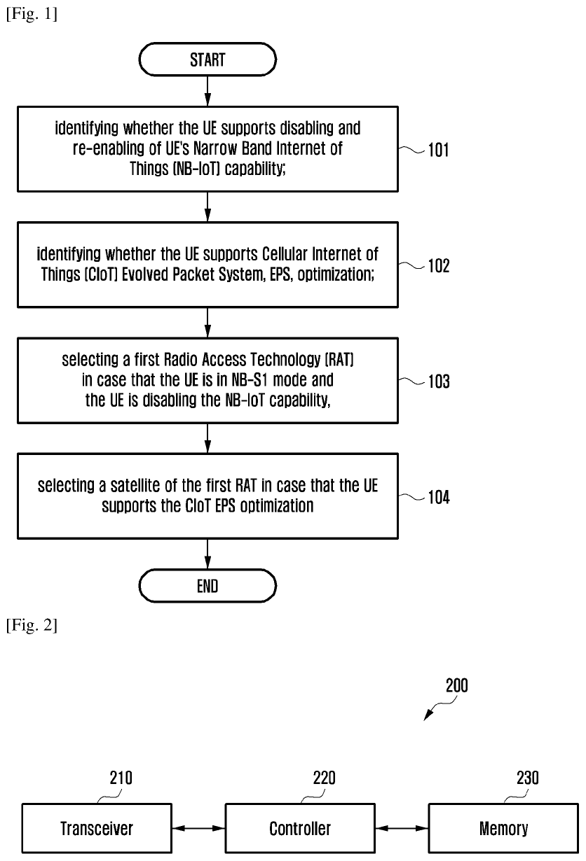

FIG. 1 shows a flowchart according to an embodiment of the present disclosure;

With reference to FIG. 1, as shown, UE identify whether the UE supports disabling and re-enabling of UE's Narrow Band Internet of Things (NB-IoT) capability (Step 101). the UE identify whether the UE supports Cellular Internet of Things (CIoT) Evolved Packet System, EPS, optimization (Step 102), and the UE select a first Radio Access Technology (RAT) in case that the UE is in NB-S1 mode and the UE is disabling the NB-IoT capability (Step 103), or select a satellite of the first RAT in case that the UE supports the CIoT EPS optimization (Step 104). the first RAT is associated with evolved Universal Terrestrial Radio Access Network (E-UTRAN). and the satellite E-UTRAN is selected via “WB-E-UTRAN(LEO)”, “WB-E-UTRAN(MEO)”, or “WB-E-UTRAN(GEO)”, of a telecommunication network, PLMN, or a PLMN from a list of equivalent PLMNs.

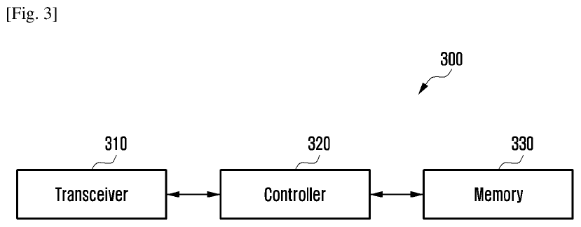

FIG. 2 shows the configuration of a user equipment (UE) according to an embodiment of the disclosure.

Referring to FIG. 2, the UE may include a transceiver 210, a controller 220, and a storage unit 230. In the embodiment, the controller 220 may be defined as a circuit, an application-specific integrated circuit, or at least one processor.

The transceiver 210 may transmit/receive signals to/from other network entities. The controller 220 may control overall operations of the UE according to the embodiment proposed in the disclosure. The storage unit 230 may store at least one piece of information transmitted/received through the transceiver 210 and information produced through the controller 220.

FIG. 3 shows the configuration of a base station according to an embodiment of the disclosure. The base station may correspond to the RAN node in the respective embodiments.

Referring to FIG. 3, the base station may include a transceiver 310, a controller 320, and a storage unit 330. In the embodiment, the controller 320 may be defined as a circuit, an application-specific integrated circuit, or at least one processor.

The transceiver 310 may transmit/receive signals to/from other network entities. The controller 320 may control overall operations of the base station according to the embodiment proposed in the disclosure. The storage unit 330 may store at least one piece of information transmitted/received through the transceiver 310 and information produced through the controller 320.

1. A method performed by a User Equipment (UE), in a wireless communication system, the method comprising:
identifying whether the UE supports disabling and re-enabling of UE's Narrow Band Internet of Things (NB-IoT) capability;
selecting a first Radio Access Technology (RAT) in case that the UE is in NB-S1 mode and the UE is disabling the NB-IoT capability, or
selecting a satellite of the first RAT in case that the UE supports Cellular of Things (CIoT) Evolved Packet System (EPS ) optimization.

2. The method of claim 1, wherein the first RAT is associated with at evolved Universal Terrestrial Radio Access Network (E-UTRAN).

3. The method of claim 1, wherein the satellite of the first RAT is selected via “WB-E-UTRAN(LEO)”, “WB-E-UTRAN(MEO)”, or “WB-E-UTRAN(GEO)”, of a registered Public Land Mobile Network (PLMN), or a PLMN from a list of equivalent PLMNs.

4. The method of claim 1, further comprising:
selecting another RAT of a registered Public Land Mobile Network (PLMN) or a PLMN from the list of equivalent PLMNs, in case that the first RAT is selected, or the satellite of the first RAT via “WB-E-UTRAN(LEO)”, “WB-E-UTRAN(MEO)”, or “WB-E-UTRAN(GEO)” of the registered PLMN or PLMN from the list of equivalent PLMNs cannot be found and the UE supports the CIoT EPS optimization.

5. The method of claim 4, wherein the other RAT is one of Global System for Mobile Telecommunication (GSM) EDGE Radio Access Network (GERAN), Universal Mobile Telecommunication System (UMTS) Terrestrial Radio Access Network (UTRAN), or New Radio-Radio Access Network (NG-RAN), in case that the UE has not disabled its NI mode capability for 3GPP access.

6. The method of claim 1, further comprising:
selecting an E-UTRA cell connected to an Evolved Packet Core (EPC) in case that the UE is disabling NI mode capability for 3GPP access for a Public Land Mobile Network (PLMN (not due to redirection to the EPC, or,
selecting a satellite E-UTRA cell connected to the EPC via “WB-E-UTRAN(LEO)”, “WB-E-UTRAN(MEO)”, or “WB-E-UTRAN(GEO)”, of a registered PLMN or a PLMN from the list of equivalent PLMNs, in case that the UE supports the CIoT EPS optimization, and the UE supports S1 mode and the UE has not disabled its E-UTRA capability.

7. The method of claim 6, further comprising:
selecting another RAT of the registered PLMN or a PLMN from the list of equivalent PLMNs that the UE supports in case that the E-UTRA cell connected to an EPC or,—the satellite E-UTRA cell connected to the EPC via “WB-E-UTRAN(LEO)”, “WB-E-UTRAN(MEO)”, or “WB-E-UTRAN(GEO)”, of the registered PLMN or PLMN from the list of equivalent PLMNs cannot be found, and the UE does not support S1 mode or the UE has disabled its E-UTRA capability;

8. The method of claim 1, further comprising:
searching for a suitable E-UTRA cell connected to an EPC, in case that the UE is in a WB-NI mode, and lower layers do not provide an indication that a current E-UTRA cell is connected to the EPC or lower layers do not provide an indication that the current E-UTRA cell supports the CIoT EPS optimizations that are supported by the UE, or,
selecting a satellite E-UTRA cell connected to the EPC via “WB-E-UTRAN(LEO)”, “WB-E-UTRAN(MEO)”, or “WB-E-UTRAN(GEO) in case that the UE supports the CIoT EPS optimization.

9. The method of claim 1, further comprising:
indicating to lower layers to remain camped in an E-UTRA cell connected to a SG Core Network (5GCN ); and
starting a timer and entering a state 5GMM-REGISTERED. LIMITED-SERVICE in case that lower layers cannot find a suitable E-UTRA cell connected to an EPC, or the lower layers cannot find a suitable satellite E-UTRA cell via “WB-E-UTRAN(LEO)”, “WB-E-UTRAN(MEO)”, or “WB-E-UTRAN(GEO)”, or there is no suitable E-UTRA cell connected to the EPC, or there is no suitable satellite E-UTRA cell connected to the EPC via “WB-E-UTRAN(LEO)”, “WB-E-UTRAN(MEO)”, or “WB-E-UTRAN(GEO)”, which supports the CIoT EPS optimizations that are supported by the UE.

10. The method of claim 9, wherein the UE re-enables N1 mode capability for 3GPP access at expiry of the timer, if the timer had been started, and then proceeds with an appropriate 5GMM procedure.

11. A User Equipment (UE) in a wireless communication system, the UE comprising:
a transceiver; and
a controller operably connected to the transceiver,
the controller configured to:
identify whether the UE supports disabling and re-enabling of UE's Narrow Band-Formatted: Indent: Left: 0.5″ Internet of Things, NB-IoT, capability;
select a first Radio Access Technology (RAT) in case that the UE is in NB-S1 mode and the UE is disabling the NB-IoT capability, or select a satellite of the first RAT in case that the UE supports of Things (CIoT) Evolved Packet System (EPS ) optimization.

12. The UE of claim 11, wherein the first RAT is associated with an evolved Universal Terrestrial Radio Access Network, E-UTRAN.

13. The UE of claim 12, wherein the satellite of the first RAT is selected via “WB-E-UTRAN(LEO)”, “WB-E-UTRAN(MEO)”, or “WB-E-UTRAN(GEO)”, of a registered Public Land Mobile Network (PLMN), or a PLMN from a list of equivalent PLMNs.

14. The UE of claim 11, wherein the controller is further configured to:
select another RAT of a registered Public Land Mobile Network (PLMN) or a PLMN from the list of equivalent PLMNs, in case that the first RAT is selected, or the satellite of the first RAT via “WB-E-UTRAN(LEO)”, “WB-E-UTRAN(MEO)”, or “WB-E-UTRAN(GEO)” of the registered PLMN or the PLMN from the list of equivalent PLMNs cannot be found and the IDE supports the CIoT EPS optimization.

15. The UE of claim 14, wherein the other RAT is one of Global System for Mobile Telecommunication (GSM) EDGE Radio Access Network (GERAN), Universal Mobile Telecommunication System (UMTS) Terrestrial Radio Access Network (UTRAN), or New Radio-Radio Access Network (NG-RAN), in case that the UE has not disabled its N1 mode capability for 3GPP access.
